(19) United States
(12) Patent Application Publication
(10) Pub. No.: US 2012/0268397 A1
(43) Pub. Date: Oct. 25, 2012

(54) TOUCH SCREEN CONTROLLER USING DIFFERENTIAL SIGNAL PROCESSING

(76) Inventors: Jonghwa LEE, Seoul (KR); Sanghyub Kang, Seoul (KR); Woohyoung Seo, Seoul (KR)

(21) Appl. No.: 13/352,505

(22) Filed: Jan. 18, 2012

(30) Foreign Application Priority Data
Apr. 19, 2011 (KR) 10-2011-0036373

(51) Int. Cl. G06F 3/041

(52) U.S. Cl. 345/173

(57) ABSTRACT

A touch screen controller using differential signal processing includes a charge amplifier, a first variable gain amplifier, one or more second variable gain amplifiers, a channel integrator, and a linearizer. The charge amplifier converts a charge output from a touch panel into a voltage and output a single-ended signal. The first variable gain amplifier removes an offset except touch information existing on a path sensing signal. The one or more second variable gain amplifiers removes an offset between channels while referring to a line signal input to the first variable gain amplifier. The channel integrator performs integration on the signal output from the first and the second variable gain amplifier and return a common reference to a pixel result, and the linearizer performs linearization by detecting a linearization factor and a phase error of the output signal of the channel integrator.

The present invention claims priority to Korean Patent Application No. 10-2011-0036373 (filed on Apr. 19, 2011), which is hereby incorporated by reference in its entirety.

### BACKGROUND

The development of various digital devices requires various user input devices applied thereto. Conventionally, a keyboard or a mouse has been used in a personal computer, and a button-type keypad has been used in a mobile phone and a digital camera. More recently however, the application of a touch screen which receives a command through a user's contact in a field which requires the user's input such as an input device for a mobile phone or a multimedia player (e.g., a PMP, a pad or the like) is increasing exponentially.

The touch screen detects the user's contact and transmits a command corresponding to the detected contact to a digital device.

The conventional touch screen can sense only a user's single touch, however, allowing recognition of a user's multi touches have been considered.

As an example of a multi-touch method using a touch screen, there has been proposed a method including the steps of: applying an AC transition to each channel by using a charge amplifier (CA), a V-to-I converter (VIC), a position encoder (PE), a MAC detector, a MIN detector, a touch pressure extractor (ZSUM) and the like; holding an output of the charge amplifier; removing, when all channels are held, a minimum value obtained during the holding operation from the charge amplifier; obtaining X and Y coordinates by calculating a one-dimensional weighted average of the output of the charge amplifier from which the offset is removed; and obtaining a pressure as Z information by one-dimensional sum of the X and Y information.

However, since this touch type method is a single-ended signal processing method, it is disadvantageous in that a common noise cannot be sampled or rejected; it has low tolerance to overcome noise; and an ACD dynamic range cannot be utilized.

As another example of the multi-touch type method, there has been proposed a method for controlling a surface of a multi-touch screen by using a charge amplifier for converting a charge into a voltage, a signal multiplier for receiving and demodulating an output of the charge amplifier, and a demodulation lookup table in which a shape and an amplitude of a demodulated waveform, a coefficient of a frequency and the like are programmed.

However, since this touch type method is also a single-ended signal processing method, it is disadvantageous in that a common noise cannot be sampled or rejected; an ADC dynamic range cannot be utilized; and an offset removal process is too complicated.

### SUMMARY

Embodiments relate to a touch screen controller using differential signal processing which can improve a dynamic range and noise immunity by applying a differential signal to a touch screen for detecting contact/noncontact of a user or a contact position.

In accordance with embodiments, a touch screen controller using differential signal processing may include: a charge amplifier for converting a charge output from a touch panel into a voltage and outputting a single-ended signal; a first variable gain amplifier for removing an offset except touch information existing on a path sensing signal preset for differential processing of the output signal of the charge amplifier, one or more second variable gain amplifiers for removing an offset between channels while referring to a line signal input to the first variable gain amplifier; a channel integrator for performing integration on the signal output from the first and the second variable gain amplifiers from a first channel and returning a common reference to a pixel result; and a linearizer for performing linearization by detecting a linearization factor and a phase error of the output signal of the channel integrator.

The touch panel may have at least one path in which driving is performed on an X coordinate and sensing is performed on a Y coordinate.

The first and the second variable gain amplifiers may receive a reference signal and record the received reference signal in a first sensing channel as a common reference between lines.

Further, the reference signal may be selected from among a sine waveform, a pulse waveform, and a triangular waveform.

Further, the touch screen controller using differential signal processing may further include an anti-alias filter for performing anti-alias filtering on an output signal of the charge amplifier and transmitting the filtered signal to the first and the second variable gain amplifiers.

Further, the touch screen controller using differential signal processing may further include an anti-alias filter for performing anti-alias filtering on an output signal of the charge amplifier and transmitting the filtered signal to the demodulator.

Furthermore, the touch screen controller using differential signal processing may further include an anti-alias filter for performing anti-alias filtering on an output signal of the first and the second variable gain amplifiers and transmitting the filtered signal to the channel integrator.

Further, the touch screen controller using differential signal processing may further include an analog-digital converter for converting an analog signal output from the first and the second variable gain amplifier to a digital signal and transmitting the digital signal to the channel integrator.

Further, the touch screen controller using differential signal processing may further include a demodulator for detecting a phase of the signal output from the channel integrator, scrambling a random noise by applying an absolute function, and transmitting the scrambled signal to the linearizer.

In accordance with embodiments, a touch screen controller using differential signal processing may include: a charge amplifier for converting a charge output from a touch panel to a voltage and outputting a single-ended signal; a demodulator for coupling a phase of a demodulated waveform to a phase of each path sensing signal included in the output signal of the charge amplifier; a first variable gain amplifier for removing an offset except touch information existing on a path sensing signal preset for differential processing of the signal output from the demodulator; one or more second variable gain amplifiers for removing an offset between channels while referring to a line signal input to the first variable gain amplifier, a channel integrator for performing integration on the signal output from the first and the second variable gain amplifiers from a first channel and returning a common reference to a pixel result; and a linearizer for performing linearization by detecting a linearization factor and a phase error of the output signal of the channel integrator.

Further, the touch screen controller using differential signal processing may further include an anti-alias filter for performing anti-alias filtering on the signal output from the demodulator and transmitting the filtered signal to the first and the second variable gain amplifier.

Further, the touch screen controller using differential signal processing may further include an anti-alias filter for performing anti-alias filtering on the signal output from the charge amplifier and transmitting the filtered signal to the modulator.

Furthermore, the touch screen controller using differential signal processing may further include a sample and hold for sampling the signal output from the first and the second variable gain amplifiers within a preset period of time; and a multiplexer for converting the sampled signal into a single-ended signal and transmitting the single-ended signal to the channel integrator.

Further, the touch screen controller using differential signal processing may further include an analog digital converter for converting an analog signal output from the multiplexer into a digital signal and transmitting the digital signal to the channel integrator.

Further, the channel integrator may detect phase information based on the signal output from the first and the second variable gain amplifiers in order to minimize a phase error.

Further, the linearizer may include a first linearizer for reducing a differential phase error based on the signal output from the first and the second variable gain amplifiers; and a second linearizer for detecting touch position information of the touch panel by a linearization factor.

In accordance with embodiments, a touch screen controller using differential signal processing may improve a dynamic range by maximizing the effect of an ADC dynamic range (or maximizing sensing accuracy) by removing a touch offset and a non-touch offset on an individual path before analog-digital conversion and improve noise immunity by real-time common mode cancellation of a noise on a path sensing signal transmitted from outside of a chip.

### DRAWINGS

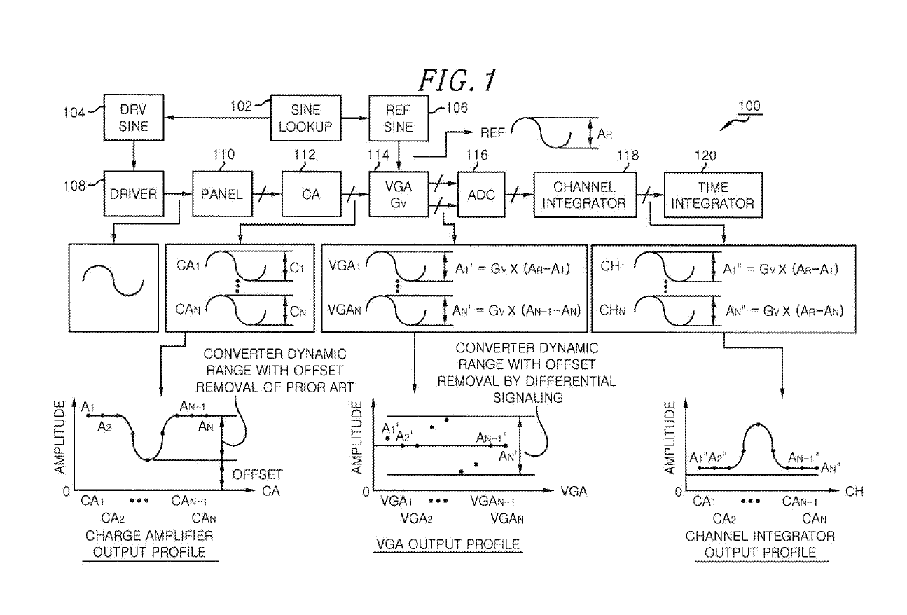

Example FIG. 1 is a block diagram illustrating a configuration of a touch screen controller in accordance with embodiments.

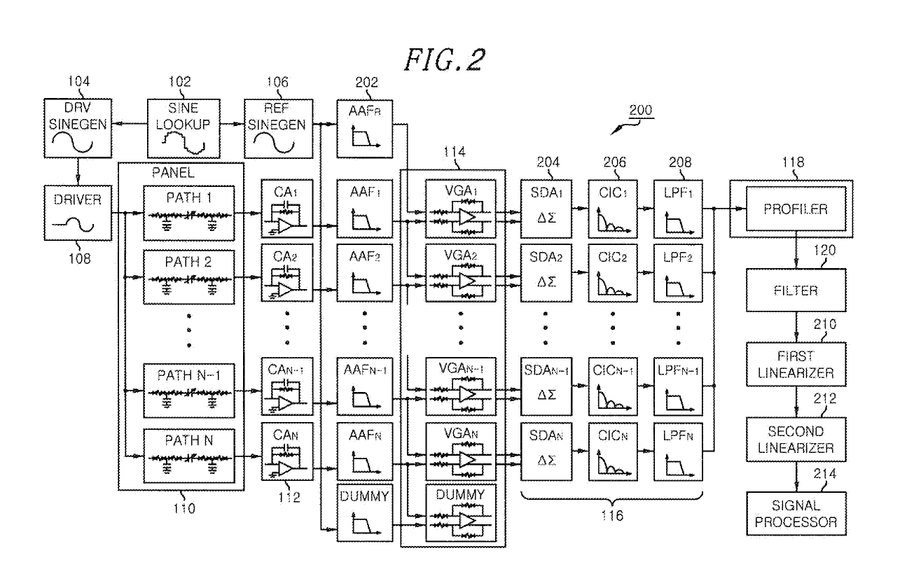

Example FIG. 2 is a block diagram illustrating a detailed configuration of the touch screen controller in accordance with embodiments.

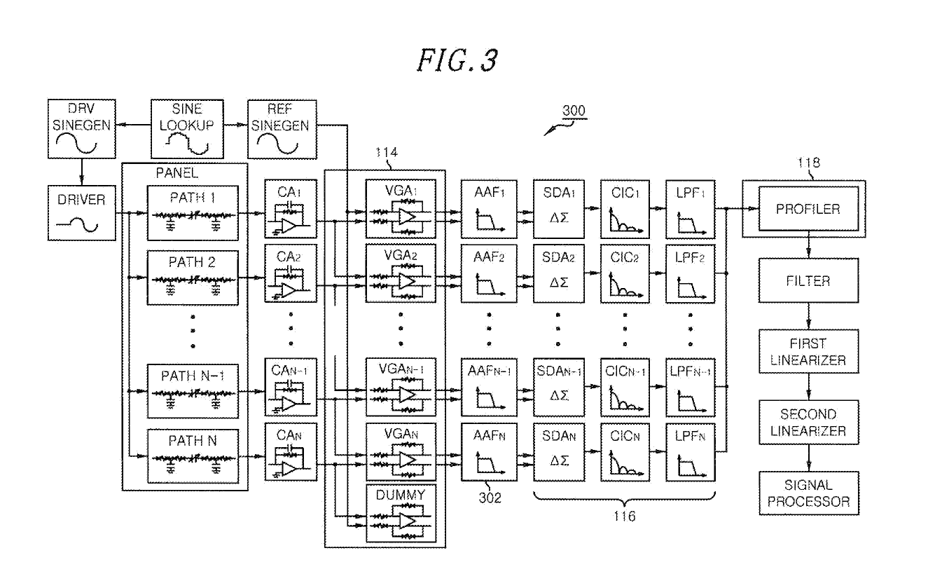

Example FIG. 3 is a block diagram illustrating a detailed configuration of a touch screen controller in accordance with embodiments.

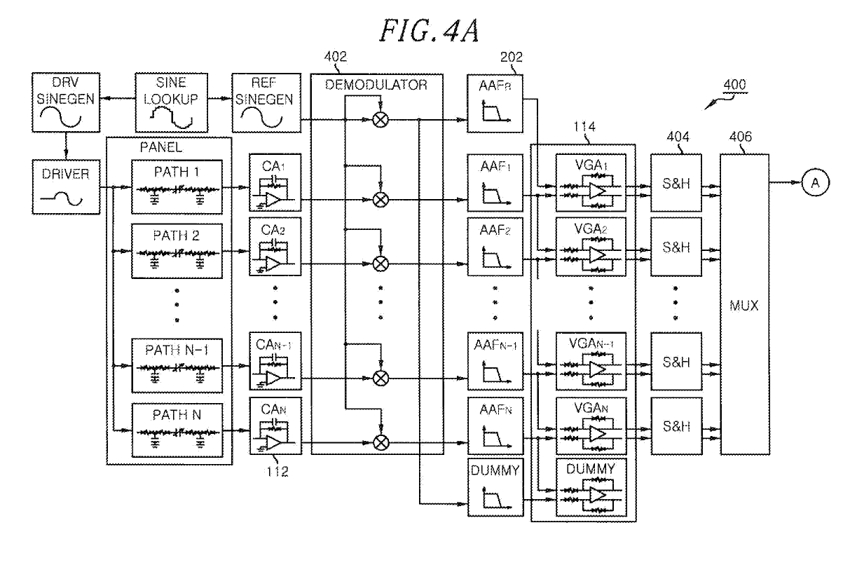

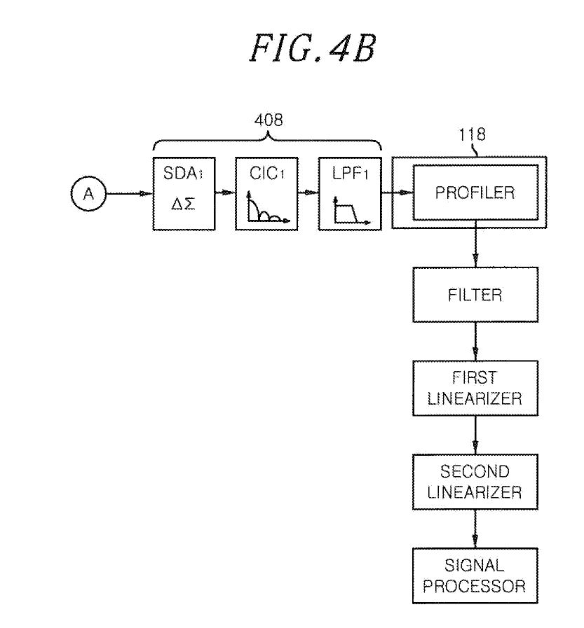

Example FIGS. 4A and 4B are block diagrams illustrating a detailed configuration of a touch screen controller in accordance with embodiments.

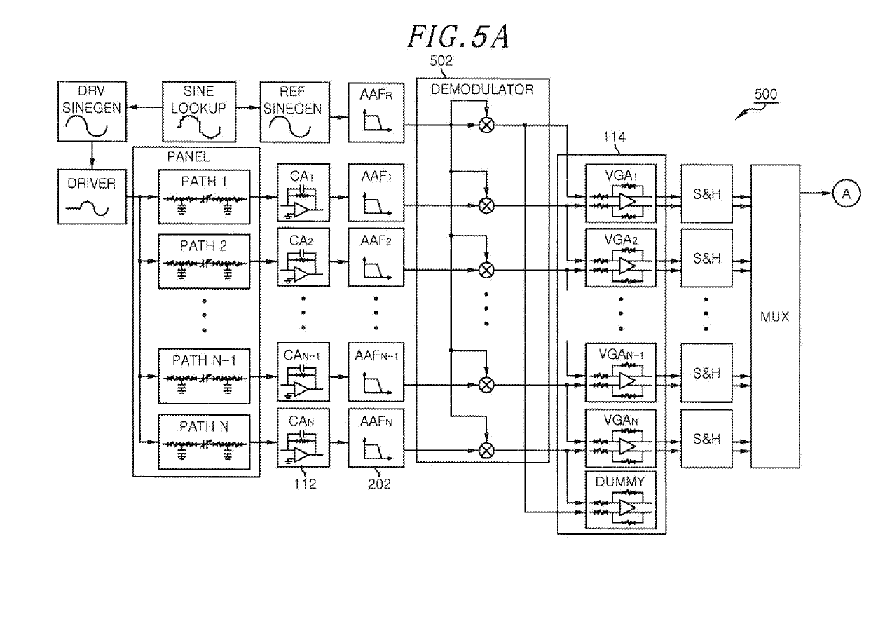

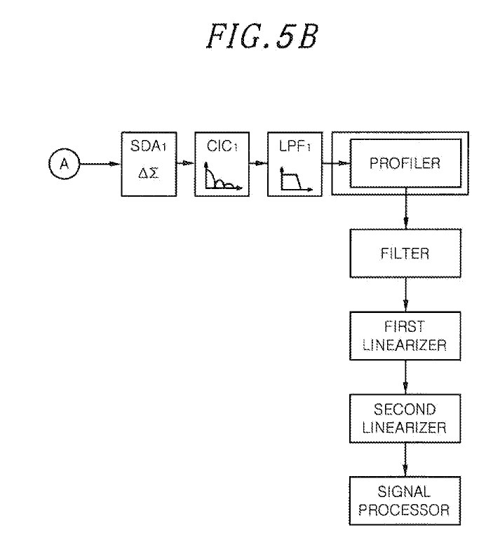

Example FIGS. 5A and 5B are block diagrams illustrating a detailed configuration of a touch screen controller in accordance with embodiments.

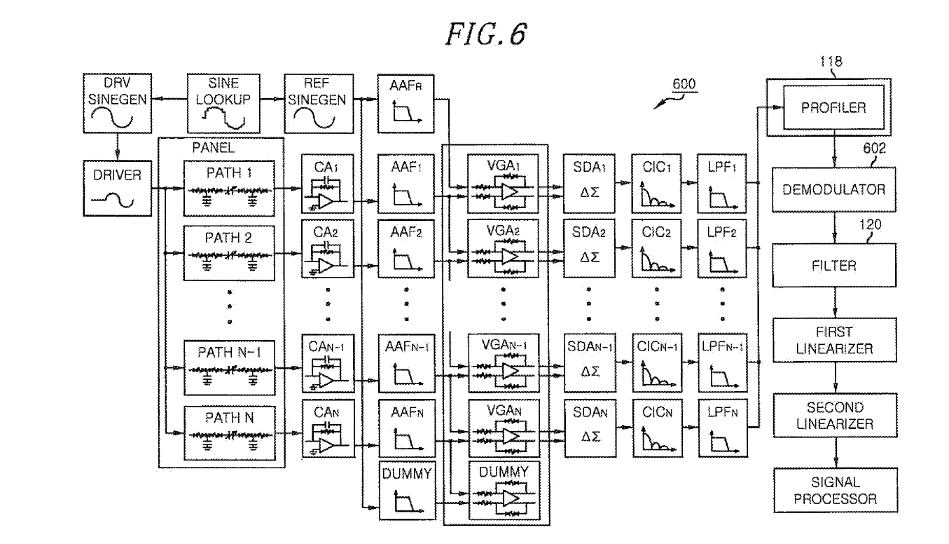

Example FIG. 6 is a block diagram illustrating a detailed configuration of a touch screen controller in accordance with embodiments.

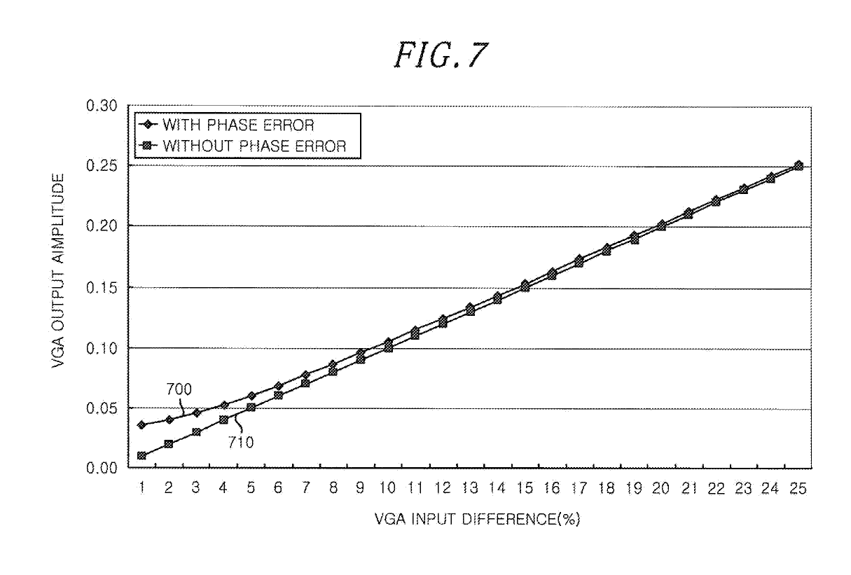

Example FIG. 7 is a graph illustrating variation in an output amplitude in accordance with a phase error effect of a variable gain amplifier in accordance with embodiments.

### DESCRIPTION

Embodiments may improve a dynamic range and reduce a common noise by applying a differential signal to a touch screen controller for detecting contact/noncontact of a user or a contact position.

Example FIG. 1 is a block diagram illustrating a configuration of a touch screen controller in accordance with embodiments.

Referring to Example FIG. 1, a touch screen controller 100 may include a sine lookup table 102, a drive sine generator 104, a reference sine generator 106, a driver 108, a panel 110, a charge amplifier (CA) 112, a variable gain amplifier (VGA) 114, an analog digital converter (ADC) 116, a channel integrator 118, and a time integrator 120.

Specifically, the sine lookup table 102 can provide driving signals for the panel 110 and the reference sine generator 106. An AC waveform for driving a panel may be a pulse waveform, a sine waveform, a triangular waveform, or the like.

In embodiments, when an analog front end processing is performed, a sine waveform can be used as a driving signal in order to minimize the effect of a high frequency tone generated from a driving source and reduce the effect of an on-chip noise on an analog region and an electromagnetic interface (EMI).

The drive sine generator 104 can use a DAC and a low resolution lookup table to generate a sine waveform. This is due to the panel pass characteristics having a band-pass filter effect; and an analog front end (AFE) and a digital post-filter having a high frequency tone suppression effect.

When the reference sine generator 106 uses a driving signal and an uncorrelated DC signal as a reference input of a first channel, a DC offset may exist between the driving signal and the reference signal. The corresponding offset may be amplified by the variable gain amplifier (VGA) 114 and generates an ADC overflow. Thus, the VGA gain of the first channel should be set to be smaller than those of other channels only using an input correlated to a driving signal.

Further, when the gain of the first channel is different from that of another channel operating in a differential mode, a profiling error may occur during channel integration due to channel gain mismatch.

In order to avoid the channel gain mismatch and reduce the offset existing on the input of the variable gain amplifier 114, a sine waveform can be used, instead of a DC signal, for reference of the first channel in which a relative level between X-driving lines is recorded.

The driver 108 can drive the panel 110 by outputting a driving signal based on the sine waveform transmitted from the drive sine generator 104 and transmitting the driving signal to the panel 110.

The panel 110 may receive a user's touch and sense a touch position, and may include at least one path in which the driving is performed on the X coordinate and the sensing is performed on the Y coordinate. Further, the charge amplifier (CA) 112 may operate as a charge-voltage converter and can amplify the signal output from the panel.

The variable gain amplifier (VGA) 114 can effect common mode suppression for a noise added from outside of the chip by obtaining the difference between the outputs of the charge amplifier correlated to the driving signal.

Unlike related art techniques for mapping a touch dynamic range to a converter dynamic range by removing a predefined offset from the output of the correlated charge amplifier 112, it may be possible to remove all offsets except the touch information existing on the sensing signal by obtaining the difference between continuous paths adjacent to each other.

The difference between the paths may be obtained to reduce the VGA input phase difference. When line-by-line driving is performed, the line processing is temporarily separated, and thus the difference between the lines cannot be obtained.

In order to compare the lines, the common reference between the lines is required. In embodiments, the output of the reference sine generator 106 may be used as the reference between the lines, and the generated reference sine is recorded in the first sensing channel. Hence, when the profile of the sensing line is finally reconstructed by the channel integration, the corresponding common reference is returned to each pixel result.

The analog digital converter (ADC) 116 can perform sigma delta ADC on the signal output from the variable gain amplifier 114 while considering an area, a power, a speed, a noise performance and the like.

The channel integrator 118 may reconstruct an offset for each touch pixel and can function as a profiler. In the related art, each sensing channel output contains the common reference information. However, in embodiments, other channels except the first sensing channel do not contain reference information. In order to determine the touch information of each pixel, the integration is performed on the outputs of the channels that have processed the difference between the paths from the first channel containing the common reference information. Accordingly, the common reference can be returned to the pixel result.

A channel integrator output profile may be defined as in the following Eq. (1).

Aᵢ=Gᵥ×(A_{R}−Aᵢ) Eq. (1)

Here, Aᵢ represents an amplitude of an ith channel integrator output; Gᵥ represents a gain of the VGA; A_{R} represents an amplitude of the reference VGA; and Aᵢ represents an amplitude of the ith VGA output.

As described above, the channel integrator 118 can return the lost reference information to the final result by using the combination of the path sensing signals during the differential signal processing.

The time integrator 120 may perform integration on the output value of the channel integrator 118 by using the time value and can function as a filter.

Example FIG. 2 is a block diagram illustrating a detailed configuration of a touch screen controller in accordance with embodiments.

Referring to Example FIG. 2, the touch screen controller 200 may include a sine lookup table 102, a drive sine generator 104, a reference sine generator 106, a driver 108, a panel 110, a charge amplifier (CA) 112, an anti-alias filter (AAF) 202, a variable gain amplifier (VGA) 114, an analog digital converter (ADC) 116, a channel integrator (profiler) 118, a time integrator (filter) 120, a first linearizer 210, a second linearizer 212, and a signal processor 214.

In the touch screen controller 200, the drive sine generator 104 can convert a sine waveform transmitted from the sine lookup table 102 into an analog voltage by using the DAC and transmit the converted sine waveform to the driver 108.

The driver 108 that has received the converted sine waveform from the drive sine generator 104 can transmit to the panel 110 the converted waveform as a driving signal for driving the panel 110. The panel 110 can detect at least a user's single touch and may have a plurality of paths 1 to N.

The paths 1 to N may perform driving and sensing for a mutual capacitance pixel. When the X-driving is performed, a driving signal is applied to one line. The Y-sensing is performed on an n-number of lines by the line-by-line driving and the mutual capacitance of the X-Y crossing point. The PATH i can indicate a signal path passing through an i-th mutual capacitance pixel positioned on the corresponding drive line.

The charge output from the panel 110 can be converted into a voltage by the charge amplifier 112 and then transmitted to the anti-alias filter 202. The anti-alias filter 202 may perform anti-alias filtering before the analog signal is converted into the digital signal in order to suppress the alias phenomenon.

The anti-alias filter 202 can use, e.g., a passive AA F, and can be positioned at a front end of the variable gain amplifier 114 in order to avoid charge sharing between the ADC 116 and the anti-alias filter 202 and prevent increase in the number of passive components of the differential path compared to that of the single path.

The signal filtered by the anti-alias filter 202 can be transmitted to the variable gain amplifier 114. In the variable gain amplifier 114, when the differential signal processing is performed on the single-ended output of the charge amplifier 112 before ADC, the offsets except the touch information existing on the path sensing can be removed by using the combination of the preset path sensing signals instead of the conventional common reference signal.

The signal from which the offset is removed may be converted to a digital signal by the ADC 116 and then transmitted to the channel integrator 118. The ADC 116 may include at least one serial data (SDA) 204 for converting parallel data into serial data, at least one cascaded integrated comb (CIC) 206 for constantly generating an output signal having a desired bit number by integration of a single bit signal, and at least one low pass filter (LPF) 208 for passing a low frequency component.

The channel integrator 118 may reconstruct an offset for each touch pixel and perform channel integration. The time integrator 120 can perform time integration.

The first linearizer 210 can perform linearization for reducing a differential phase error of a signal received from the time integrator 120. The sensing channels may have different panel paths and different propagation delays, so that the input phase difference of the variable gain amplifier 114 can be reflected to the amplitude and the phase of the output of the variable gain amplifier 114 as defined in the following Eqs. (2) and (3).

VGA Inputs

y₁=M₁ sin(ω₁t)

y₂=M₂ sin(ω₁t+φ), Eq. (2)

where
M₁, M₂: Touch Information in each channel
φ: Phase Error in VGA inputs
ω₁: Frequency of the driving signal
y₁: Input of the 1st channel VGA
y₂: Input of the 2nd channel VGA

VGA Output

$$\begin{matrix}{y}_{12} = {M}_{1} sin ( {ω}_{1} t ) - {M}_{2} sin ( {ω}_{1} t + ϕ ) \\ = {M}_{1} sin ( {ω}_{1} t ) - {M}_{2} [ sin ( {ω}_{1} t ) cos ( φ ) + cos ( {ω}_{1} t ) sin ( φ ) ] \\ = [ {M}_{1} - {M}_{2} cos ( φ ) ] sin ( {ω}_{1} t ) + {M}_{2} cos ( \frac{π}{2} - φ ) cos ( {ω}_{1} t ) \\ = r sin ( {ω}_{1} t + α ) ,\end{matrix} \\ where \\ a = {M}_{1} - {M}_{2} cos ( φ ) , b = {M}_{2} cos ( \frac{π}{2} - φ ) \\ VGA Output Amplitude \text{:} r = \sqrt{{a}^{2} + {b}^{2}} \\ VGA Output Phase \text{:} α = {sin}^{- 1} \frac{b}{r} \\ {y}_{12} \text{:} Output of the 1 st channel VGA \qquad Eq . ( 3 )$$

The amplitude and the phase of the output of the variable gain amplifier 114 may be affected by the input phase difference as well as the input difference (touch information) of the variable gain amplifier 114.

The effect of the input phase difference of the variable gain amplifier 114 on the output amplitude of the variable gain amplifier 114 is illustrated in example FIG. 7.

Example FIG. 7 is a graph illustrating variation in the output amplitude in accordance with the input phase error effect of the variable gain amplifier in accordance with embodiments.

Referring to example FIG. 7, there is illustrated the variation in the output amplitude in accordance with existence of the phase error 700 or nonexistence of the phase error 710. A nonlinear deformation may occur such that an error is maximized when the input differential amplitude of the variable gain amplifier 114 is low while maintaining the monotonicity of the output amplitude of the variable gain amplifier 114 with respect to the input differential amplitude of the variable gain amplifier 114.

In order to remove the nonlinear deformation, the linearization can be performed during normal operation by detecting a linearization factor by using the reference sine waveform and the path sensing waveform of the variable gain amplifier 114 of the first channel during calibration. The linearization factor can be detected by inputting a phase relationship corresponding to the input phase difference of the variable gain amplifier 114 of the channel required for linearization to the variable gain amplifier 114 of the first channel by controlling the phase of the reference sine generator 106 and linearly sweeping the amplitude of the drive sine generator 104.

As described above, the first linearizer 210 may perform linearization by detecting the phase error and the linearization factor during calibration in order to avoid the mixing of the touch information and the phase error caused by the differential signal processing.

The second linearizer 212 may receive the linearized signal from the first linearizer 210, perform linearization for reducing the charge position dependence, and transmit the linearized signal to the signal processor 214.

The signal processor 214 can perform processes such as coordinates, pressure, size, object, gesture and the like on the signal transmitted from the second linearizer 212.

Example FIG. 3 is a block diagram illustrating a detailed configuration of a touch screen controller in accordance with embodiments.

Referring to example FIG. 3, the touch screen controller 300 may have a configuration similar to that of the touch screen controller 200 of example FIG. 2 except that the touch screen controller 300 may include an anti-alias filter 302 between the variable gain amplifier 114 and the ADC 116.

In other words, the variable gain amplifier 114 can output a signal from which an offset except touch information existing on a path sensing signal is removed, and then transmit this signal to the anti-alias filter 302.

Then, the anti-alias filter 302 can perform anti-alias filtering and transmit the filtered signal to the ADC 116. The analog signal can be converted into a digital signal by the ADC 116 and then transmitted to the profiler 118.

Example FIGS. 4A and 4B are block diagrams illustrating a detained configuration of a touch screen controller in accordance with embodiments.

Referring to example FIGS. 4A and 4B, the touch screen controller 400 may have a configuration that is similar to that of the touch screen controller 200 of example FIG. 2 except that the touch screen controller 400 may include a demodulator 402 between the charge amplifier 112 and the anti-alias filter 202.

The demodulator 402 may function as an analog mixer by matching a phase of a demodulated waveform with a phase of each path sensing signal in the case of performing demodulation by using an analog mixer positioned at a rear end or a front end of the variable gain amplifier 114.

The demodulator 402 positioned at a front end of the variable gain amplifier 114 may perform matching by detecting a phase delay of each path during calibration. The effects of the phase difference between the demodulated waveform and the path detection waveform can be calculated by a gain error term which is not related to the size of the path detection waveform (e.g., touch information).

In order to minimize the phase error, the demodulator 402 can detect and demodulate by a phase suitable for each path sensing signal.

The signal transmitted from the demodulator 402 can be subjected to anti-alias filtering by the anti-alias filter 202 and then transmitted to the variable gain amplifier 114. The variable gain amplifier 114 can remove the offsets except the touch information existing on the path sensing signal.

The signal output from the variable gain amplifier 114 can be transmitted to a sample & hold (S&H) 404 circuit. In the S&H 404 circuit, the received signal is sampled within a preset period of time and then transmitted to a multiplexer 406. The sampled signal can be transmitted to the channel integrator (profiler) 118 after the multiple input data is output as the single-ended data by the multiplexer 406 and the analog signal is converted into the digital signal by an ADC 408.

In embodiments, the demodulator 402 may be positioned at a rear end of the variable gain amplifier 114, whereby the output phase of the variable gain amplifier 114 is changed by the input amplitude of the variable gain amplifier 114. Thus, real-time phase detection is required for accurate phase matching.

When a practical real-time phase detection method is not available, a fixed phase needs to be applied for each path during demodulation. Hence, when an intermediate phase (φ/2) of two input phases related to the output of the variable gain amplifier 114 is used as the phase of the demodulated waveform, the effect of the input phase of the variable gain amplifier 114 on the output amplitude of the variable gain amplifier 114 can be minimized. By detecting the fixed phase of the input path of the variable gain amplifier 114 during calibration, a phase suitable for each path can be applied to the demodulation.

Example FIGS. 5A and 5B are block diagrams illustrating a detained configuration of a touch screen controller in accordance with embodiments.

Referring to example FIGS. 5A and 5B, the touch screen controller 500 is similar to the touch screen controller 400 of example FIGS. 4A and 4B except in that the touch screen controller 500 may include the demodulator 502 between the anti-alias filter 202 and the variable gain amplifier 114.

The signal output from the charge amplifier 112 can be subjected to anti-alias filtering by the anti-alias filter 202 and then transmitted to the demodulator 502.

The demodulator 502 may perform matching by detecting the phase delay of each path from the filtered signal, and then transmit the corresponding signal to the variable gain amplifier 114. The variable gain amplifier 114 may remove the offset existing on the path sensing signal.

Example FIG. 6 is a block diagram illustrating a detailed configuration of a touch screen controller in accordance with embodiments.

Referring to example FIG. 6, the touch screen controller 600 has a configuration that is similar to that of the touch screen controller 200 of example FIG. 2 except in that the touch screen controller 600 may include a demodulator 602 between a channel integrator (profiler) 118 and a filter 120.

At this time, the demodulator 602 may serve as a digital mixer and may have limits in the phase detection as in the case of providing an analog mixer at the rear end of the variable gain amplifier 114.

In other words, when the demodulator 602 is provided at the rear end of the ADC, i.e., between the channel integrator (profiler) 118 and the time integrator (filter) 120, the ADC requires an input bandwidth greater than a carrier frequency. However, it may be advantageous in that a signal mixing required for demodulation can be simplified.

The demodulated waveform may be a waveform matched with a driving waveform, or a waveform having characteristics of a band-pass filter (BPF) (e.g., a Gaussian/Bell Shaped Sine Waveform) or a pulse waveform (e.g., Rectify Function). In embodiments, the phase error may be scrambled by random noise, so that only the absolute function is applied to the position of the digital mixer type demodulator 602, instead of applying the demodulation (signal mixer) by detecting the phase to simplify the phase detection and the demodulation.

In other words, when the absolute sum is obtained by using a phase error, the demodulation can be simplified as the absolute sum by using the random noise scrambling effect.

According to embodiments, the modulator 602 may be applied to the front end of the ACD, thereby down-converted the touch information from a carrier frequency (e.g., a driving frequency) to a base band. Hence, the ADC input bandwidth requirement can be reduced.

As described above, embodiments may improve a dynamic range and noise immunity by applying a differential signal to a touch screen controller for detecting contact/noncontact of a user or a contact position.

Although embodiments have been shown and described herein, it should be understood that numerous other changes and modifications may be made by those skilled in the art without departing from the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A touch screen controller using differential signal processing, the touch screen controller comprising:
a charge amplifier configured to convert a charge output from a touch panel into a voltage and output a single-ended signal;
a first variable gain amplifier configured to remove an offset except for touch information existing on a path sensing signal preset for differential processing of the single-ended signal output from the charge amplifier;
at least one second variable gain amplifier configured to remove an offset between channels while referring to a line signal input to the first variable gain amplifier;
a channel integrator configured to perform an integration on the signal output from the first and the at least one second variable gain amplifiers from a first channel and returning a common reference to a pixel result; and
a linearizer configured to perform a linearization by detecting a linearization factor and a phase error of an output signal of the channel integrator.

2. The touch screen controller of claim 1, wherein the touch panel comprises at least one path in which driving is performed on an X coordinate and sensing is performed on a Y coordinate.

3. The touch screen controller of claim 1, wherein the first and the at least one second variable gain amplifiers receive a reference signal and records the received reference signal in a first sensing channel as a common reference between lines.

4. The touch screen controller of claim 3, wherein the reference signal is one of a sine waveform, a pulse waveform, and a triangular waveform.

5. The touch screen controller of claim 1, further comprising:
an anti-alias filter configured to perform anti-alias filtering on the single-ended signal output from the charge amplifier and transmit an anti-alias filtered signal to the first and the at least one second variable gain amplifiers.

6. The touch screen controller of claim 1, further comprising:
a demodulator configured to demodulate an anti-alias filtered signal and transmit the demodulated anti-alias filtered signal to the first and the at least one second variable gain amplifiers.

7. The touch screen controller of claim 6, further comprising:
an anti-alias filter configured to perform anti-alias filtering on the single-ended signal output from the charge amplifier and transmit the anti-alias filtered signal to the demodulator.

8. The touch screen controller of claim 1, further comprising:
an anti-alias filter configured to perform anti-alias filtering on the signal output from the first and the at least one second variable gain amplifiers and transmit an anti-alias filtered signal to the channel integrator.

9. The touch screen controller of claim 1, further comprising:
an analog-digital converter configured to convert an analog signal output from the first and the at least one second variable gain amplifiers to a digital signal and transmit the digital signal to the channel integrator.

10. The touch screen controller of claim 1, further comprising:
a demodulator configured to detect a phase of the output signal from the channel integrator, scramble a random noise by applying an absolute function to the output signal, and transmit a scrambled signal to the linearizer.

11. The touch screen controller of claim 1, wherein the first variable gain amplifier removes all offsets except for the touch information existing on the path sensing signal by obtaining a difference between continuous paths adjacent to each other.

12. A touch screen controller using differential signal processing, the touch screen controller comprising:
a charge amplifier configured to convert a charge output from a touch panel into a voltage and output a single-ended signal;
a demodulator configured to convert a phase of a demodulated waveform to a phase of each path sensing signal included, in the output single-ended signal;
a first variable gain amplifier configured to remove an offset except for touch information existing on a path sensing signal preset for differential processing of a signal output from the demodulator;
at least one second variable gain amplifier configured to remove an offset between channels while referring to a line signal input to the first variable gain amplifier;
a channel integrator configured to perform an integration on a signal output from the first and the at least one second variable gain amplifiers from a first channel and returning a common reference to a pixel result; and
a linearizer configured to perform a linearization by detecting a linearization factor and a phase error of an output signal of the channel integrator.

13. The touch screen controller of claim 12, further comprising:
an anti-alias filter configured to perform anti-alias filtering on a signal output from the demodulator and transmit the anti-alias filtered signal to the first and the at least one second variable gain amplifier.

14. The touch screen controller of claim 12, further comprising:
an anti-alias filter configured to perform anti-alias filtering on the single-ended signal output from the charge amplifier and transmit the anti-alias filtered signal to the demodulator.

15. The touch screen controller of claim 12, further comprising:
a sample and hold circuit configured to sample a signal output from the first and the at least one second variable gain amplifier within a preset period of time; and
a multiplexer configured to convert the sampled signal into a single-ended signal and transmit the single-ended signal to the channel integrator.

16. The touch screen controller of claim 15, further comprising:
an analog digital converter configured to convert an analog signal output from the multiplexer into a digital signal and transmit the digital signal to the channel integrator.

17. The touch screen controller of claim 15, wherein the channel integrator is configured to detect phase information based on the signal output from the first and the at least one second variable gain amplifier in order to minimize a phase error.

18. The touch screen controller of claim 12, wherein the linearizer comprises:
a first linearizer configured to reduce a differential phase error based on the signal output from the first and the at least one second variable gain amplifier; and
a second linearizer configured to detect touch position information of the touch panel by a linearization factor.

19. The touch screen controller of claim 12, wherein the first variable gain amplifier removes all offsets except for the touch information existing on the path sensing signal by obtaining a difference between continuous paths adjacent to each other.

20. The touch screen controller of claim 19, wherein an input phase difference of the first and the at least one second variable gain amplifiers is reduced based on the obtained difference between continuous paths adjacent to each other.
